(19) United States
(12) Patent Application Publication
(10) Pub. No.: US 2008/0256965 A1
(43) Pub. Date: Oct. 23, 2008

(54) Heating And/Or Air Conditioning Unit For Vehicles

(75) Inventors: Alexander Bopp, Illingen (DE); Carsten Burkhardt, Kunzelsau (DE); Gebhard Schweizer, Leonberg (DE)

Correspondence Address: FOLEY AND LARDNER LLP;SUITE 500, 3000 K STREET NW, WASHINGTON, DC, 20007, US

(73) Assignee: BEHR GmbH & CO. KG, Stuttgart (DE)

(21) Appl. No.: 11/568,883

(22) PCT Filed: May 4, 2005
(86) PCT No.: PCT/EP2005/004850

§ 371 Date: Aug. 16, 2007

(30) Foreign Application Priority Data
May 13, 2004 (DE) 10 2004 024 182.1

(51) Int. Cl. B60H 1/32

(52) U.S. Cl. 62/239; 62/515

(57) ABSTRACT

The invention relates in a heating and/or air conditioning with comprising a temperature mixing flap (8) that can be driven via at least two pixel means (9) which are disposed in such a way that at least one partial area especially the wait area (10), of the mixing flap (8) performs a combined rotational and translational movement when the mixing flap (8) is moved. The aim of the invention is to improve air conditioning units such that said advantageous embodiment and pivoting of the temperature mixing flap (8) allows differently tempered air flows to be mixed more thoroughly while making the same adjustable in an optimal manner to the available assembly space.

The present invention relates to a heating and/or air conditioning unit for vehicles.

A heating and/or air conditioning unit for a vehicle is typically composed of a single-part or multiple-part housing, a fan for sucking in fresh air or circulating air, optionally a heat exchanger, in particular an evaporator for cooling the air, a second heat exchanger for heating the air, an apparatus for controlling the temperature of a main air flow, and a mixing space.

A cooled air flow which emerges from the evaporator or a fresh air flow is preferably directed as a first part air flow either via a cold air duct or directly into a mixing chamber and is fed as a second part air flow to a heat exchanger which is configured as a heating element via a further duct or a connecting section. The second part air flow which is conducted via the heating element enters the mixing space as a heated air flow and forms a main air flow after being mixed with at least one part of the first, cold part air flow.

Starting from the mixing space or the mixing chamber, the main air flow supplies the vehicle interior via different air outlet openings. These air outlet openings or vents, such as defrosting air vents, central air vents, side air vents or footwell air vents, can be loaded with different amounts of air by further control flaps.

The different volumetric flows which can be set by means of an apparatus for controlling the temperature of the air and comprise cold and heated part air flows result in the temperature of the main air flow or the air in the mixing chamber. An apparatus of this type for controlling the temperature of a main air flow which is guided from the mixing chamber into different regions or else zones of the vehicle interior usually comprises a temperature mixing flap or an arrangement of mixing flaps of this type. Targeted influencing or control of the loading of different air flow ducts is possible by means of different operating positions of a mixing flap of this type. In particular, volumetric flow ratios of two air flows with different controlled temperatures can be set, in order to achieve a defined temperature after the addition or mixing of these two or more air flows.

What are known as butterfly flaps are known for temperature mixing flaps of this type from the prior art, for example from the patent DE 3038272 C2. These are configured with two blades, are mounted rotatably or pivotably about a rotational axis and can be moved between two end positions. Here, the flap or part regions of the flap close a cold air duct completely in the first end position and at the same time open a warm air duct which guides the air flow to a heating element. The opposite case occurs in a second end position. The flap closes the duct to the heating element completely and only cold air passes into the mixing chamber via a cold air duct. In positions of the flap which lie in between, the cold and warm air ducts are partially closed or opened, with the result that a defined temperature is set in the mixing chamber, in which the two part flows are combined, as a function of the flap position.

If the flap is in a first end position, in which it, for example, closes the cold air duct, said flap is rotated by a small angle in order to achieve a slight temperature reduction of the mixing air. A narrow opening for the passage of cold air into the mixing chamber is released at one end region of that blade part of the mixing flap which closes the cold duct. It proves disadvantageous here that this opening region lies at that end of the flap which lies on that side of the flap which faces away from the warm air duct in a butterfly flap as a result of the construction. The cooled air flows along the edge region of the cold air duct past the flap end into the mixing chamber, as a result of which only slight mixing of warm and cold air is achieved. Outlet openings which are adjacent to this end region are therefore loaded predominantly with cold air, and the openings which lie further away are loaded almost exclusively with warm air. This leads to an often undesirable temperature stratification with regard to the air outlet openings from the mixing chamber. The corresponding is also true for the opposite case, in which the warm air duct which is completely closed first of all is opened slowly.

Improved mixing of the part air flows is achieved with a mixing flap of the butterfly type as a result of the spacing of the rotational axis or the flap wall in the region of the rotational axis from an edge region or end of a dividing wall between the cold and warm air ducts, with the result that direct passage of the cold air from the cold air duct into the warm air duct can take place in those positions of the mixing flap which are positioned between the end positions, and therefore improved mixing of the two part air flows is ensured before entry into the mixing chamber. However, a disadvantage of this arrangement is that, as a result of the configuration of a two-blade flap, overall flap dimensions result which are defined by the sum of the opening widths of the cold and warm air ducts. One exemplary embodiment is shown in the laid-open publication DE 3510991 A1.

An air conditioning unit having a mixing flap which solves this problem partially is known from the U.S. Pat. No. 6,231,437 B1. The temperature mixing flap is configured as a drum flap or at least as a drum-like flap. One essential feature of a drum-type flap is that it has a wall which is configured to be circular and convex with regard to the rotational axis. The overall dimensions of the wall region which is provided for closing and opening the ducts is then defined only by the maximum opening width of the larger of the two ducts. In the embodiment shown, the flap is mounted rotatably about a rotational axis. A closing wall of circular segment configuration is provided with one or more apertures or regions which are set back from the closing wall, in order to make direct passage possible of the cold air from the cold air duct into the warm air duct during the pivoting between the end positions “cold” and “warm”.

The convexly curved shape of the flap in the flow region of the deflected cold air results in a disadvantageous effect on the flow characteristics. In defined flap positions, the predominant direction of the entering cold air flow lies almost perpendicularly with respect to the closing wall. The cold air which impinges on the wall is eddied before passing into the warm air duct. The closing wall which is intended to ensure deflection of the cold air therefore forms a flow obstacle. The acoustic properties of the air conditioning unit are also impaired by the resulting increased pressure drop.

The configuration of the mixing flap in the form of a drum flap results in minimum requirements on the installation space which is required for the rotational movement of the flap. Flexible adaptation of the pivoting path is not possible.

A further disadvantage of the flaps which are known from the prior art results in the region of the sealing of the flap with respect to the housing at the end sides of the flap by the fact that the temperature mixing flap performs a pure rotational movement during operation (this is also true for the butterfly flap). Mixing flaps or temperature mixing flaps are usually provided with sealing faces on their wall or on the end or side faces. If it is sufficient that the entire flap is sealed with respect to the housing only in the end positions, a corresponding moment nevertheless has to be applied over the entire movement sequence in order to overcome the friction between the lateral or end-side sealing faces and the housing wall.

Proceeding from this prior art, it is therefore an object of the invention to provide an improved air conditioning unit which has a temperature mixing flap having a movement sequence which is adapted in an optimum manner to the desired flow and air mixing characteristics and the available installation space, and/or for the movement of which between the end positions a reduced torque is required.

This object is achieved by an air conditioning unit having the features of claim 1. Advantageous refinements are the subject matter of the subclaims.

According to the invention, an air conditioning unit has a fan for generating an air flow. An evaporator is optionally arranged downstream of this fan. After the optional evaporator or, if the latter is not present, before the entry into a mixing chamber, the air flow is divided into at least one first part air flow and at least one second part air flow. The first part air flow opens directly or via a first flow duct into a mixing chamber, while the second part air flow opens into the mixing chamber downstream of the heat exchanger via a second flow duct, in which a heat exchanger, in particular a heating element, is arranged.

A mixed or main air flow can be generated from the first and second part air flows in the mixing chamber, air outlet ducts leading from the mixing chamber into different regions or zones of the vehicle interior. The air outlet ducts, such as defrosting air ducts, central air ducts, side air ducts or footwell air ducts, are preferably assigned additional switching flaps which control the air outlet flow from the mixing chamber through the associated air outlet ducts.

A mixing flap which serves to control the temperature of the main or mixed air flow is provided with a wall region which can optionally open or close openings in the region of the mixing chamber. The mixing flap according to the invention can be moved between a first and a second end position, the wall region of the mixing flap closing the opening for the entry of the at least first part air flow into the mixing chamber completely in the first end position and opening at least partially the opening for the entry of the at least second part air flow into the mixing chamber, and the wall region of the mixing flap closing the opening for the entry of the at least second part air flow into the mixing chamber completely in a second end position and opening at least partially the opening for the entry of the at least first part air flow into the mixing chamber.

In those positions of the mixing flap which are situated between these end positions, direct passage is possible of at least one part of a first part air flow, for example the cold air flow, into the air duct of the second part air flow, for example into the warm air duct which guides the warm air flow, as a result of the configuration of at least one section of the wall region of the mixing flap and as a result of the movement type of the flap which can be coordinated correspondingly.

The mixing flap can be moved between the two end positions via at least two articulation means. Here, the mixing flap is articulated in such a way that, during the movement of the mixing flap, at least one part region of the mixing flap or of the wall region performs a movement which is composed of a rotation and a translation.

In a further advantageous refinement of the invention, the at least two articulation means of the mixing flap are mounted in each case on a rotational axis which is stationary with respect to the housing of the air conditioning unit. The rotational axes of the at least two articulation means are spaced apart from one another. The at least two articulation means of the mixing flap are preferably configured in the form of lever arms. In order to connect the articulation means to the mixing flap, the latter has means for the articulated connection. At least two articulation means are advantageously configured with identical lengths.

In order to adapt the movement sequence of the mixing flap to different requirements with regard to the profile of the air mixing or air stratification or the available installation space, at least two articulation means can be configured with different lengths in a further advantageous refinement of the invention. The rotational axis of at least one of the articulation means preferably lies in the region of the mixing space or adjacent to the housing of the air conditioning unit, and the rotational axis of one at least second articulation means preferably likewise lies in the region of the mixing space or adjacent to the housing of the air conditioning unit or in the region of the at least first or at least second part air flow.

According to the invention, the wall region of the mixing flap is configured in the context of the requirements for air mixing and distribution. For example, the mixing flap has a wall region which is continuously constant over its entire surface area and is of at least partial circular or circular segment profile in cross section.

In one further advantageous refinement of the invention, the wall region of the mixing flap is configured at least partially in an elliptic, parabolic, hyperbolic or another continuously curved shape, or at least partially as a flat surface piece.

The wall region of the mixing flap is preferably configured in one piece, in particular as a plastic injection molded part.

If satisfactory mixing of the at least first and second part air flows, preferably a cold and warm air flow, is to take place only in regions and temperature stratification is to be achieved in regions, the mixing flap can have laterally divided different wall regions. In addition, it is advantageous for desired temperature stratification of this type to provide dividing walls in regions in the housing of the air conditioning unit, in a manner which corresponds to the divided wall regions of the mixing flap.

In order to fix the mixing flap in at least one of its end positions, one or both longitudinal-side ends of the wall region are preferably configured in the form of stops or stop faces. This at least one stop can bear against a web or correspondingly manufactured protruding or set-back region of the housing wall and ensure longitudinal-side sealing of a flow duct in at least one end position. The at least one stop is preferably loaded with a sealing material, for example an elastic sealing-lip or a foamed encapsulation.

The housing is preferably configured, at least in the end positions of the mixing flap, with sealing edges, for example in the form of webs or protruding regions of the housing inner wall in the region of the end sides of the wall region of the mixing flap.

Otherwise, the invention will be explained in greater detail in the following text by using the exemplary embodiments which are shown in the drawings, in which:

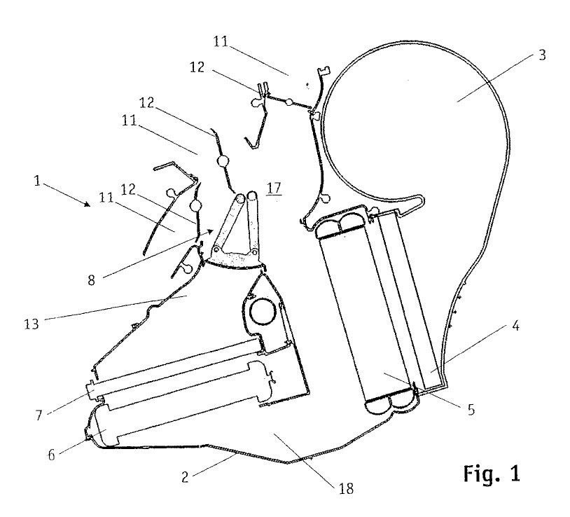

FIG. 1 shows a cross-sectional illustration through an air conditioning unit according to the invention, having a mixing flap which closes the warm air duct completely;

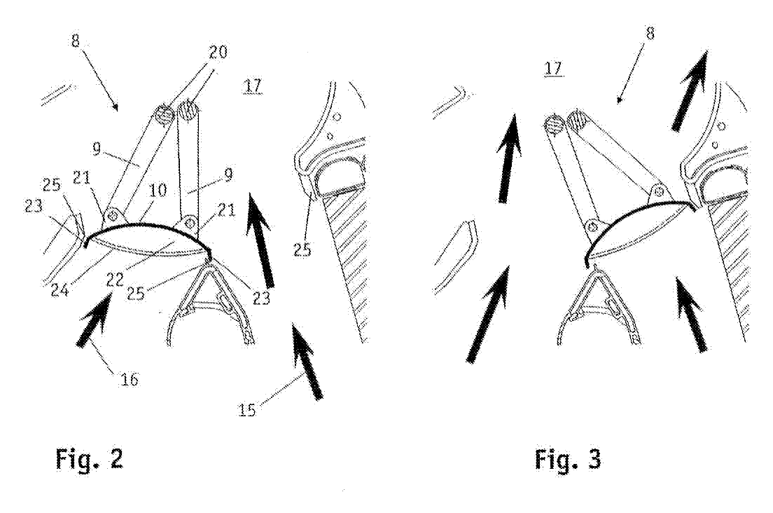

FIG. 2 shows a cross-sectional illustration through a part region of air conditioning unit according to the invention, having a temperature mixing flap which closes the warm air duct completely;

FIG. 3 shows a cross-sectional illustration through a part region of an air conditioning unit according to the invention, having a temperature mixing flap which closes the cold air duct completely;

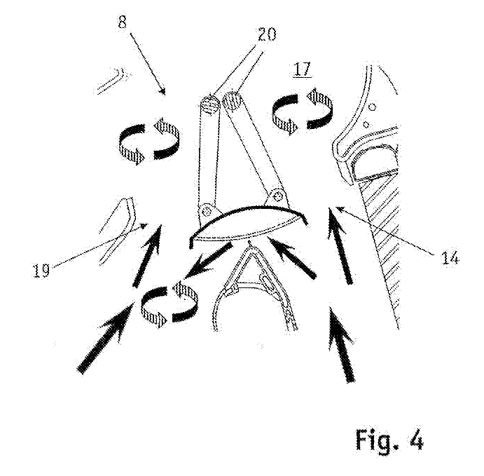

FIG. 4 shows a cross-sectional illustration through a part region of an air conditioning unit according to the invention, having a temperature mixing flap which closes the fresh air and the warm air ducts partially in an intermediate position;

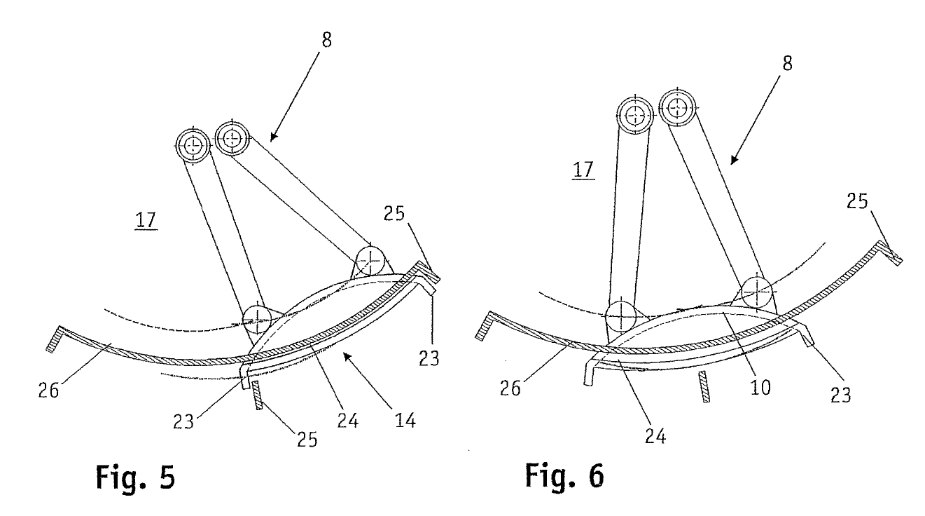

FIG. 5 shows a cross-sectional illustration of a mixing flap in one end position, having a housing sealing edge;

FIG. 6 shows a cross-sectional illustration of a mixing flap in a position which is situated between the end positions, having a housing sealing edge;

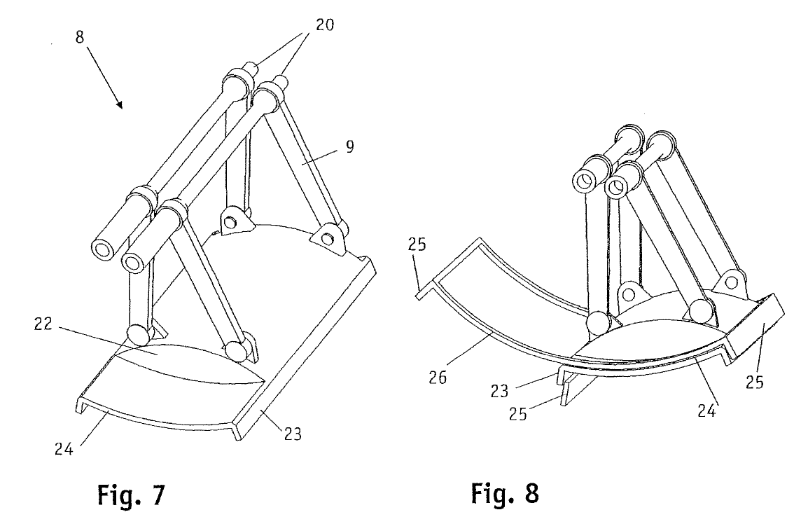

FIG. 7 shows a diagrammatic perspective illustration of a mixing flap having articulation elements;

FIG. 8 shows a diagrammatic perspective illustration of a mixing flap having articulation elements and housing sealing edges;

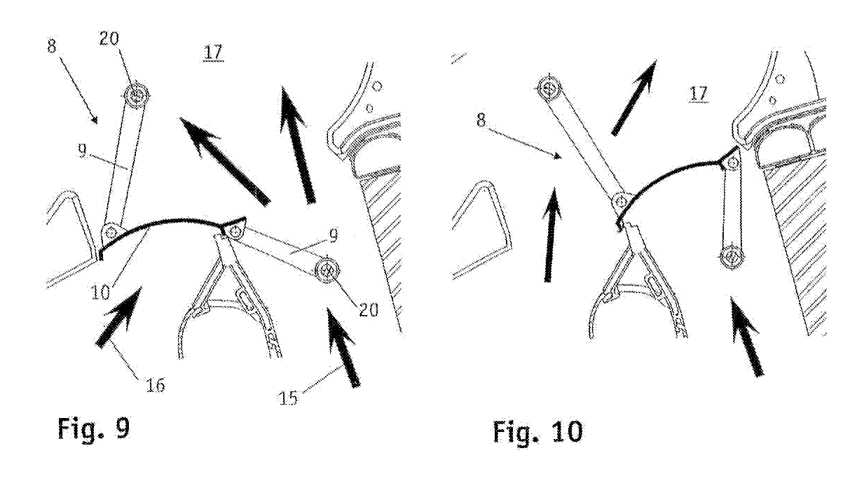

FIG. 9 shows a cross-sectional illustration through a part region of an air conditioning unit according to the invention, having a temperature mixing flap in a second embodiment, which closes the warm air duct completely;

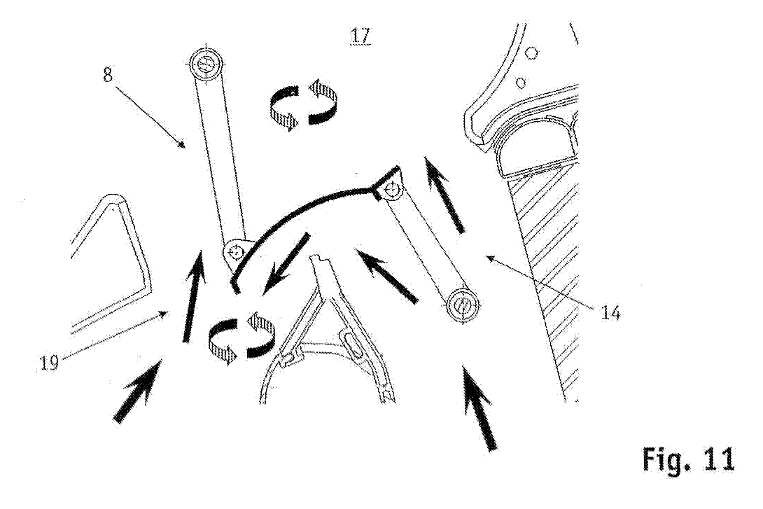

FIG. 10 shows a cross-sectional illustration through a part region of an air conditioning unit according to the invention, having a temperature mixing flap in a second embodiment, which closes the cold air duct completely;

FIG. 11 shows a cross-sectional illustration through a part region of an air conditioning unit according to the invention, having a temperature mixing flap in a second embodiment, which closes the fresh air and warm air duct partially in an intermediate position; and

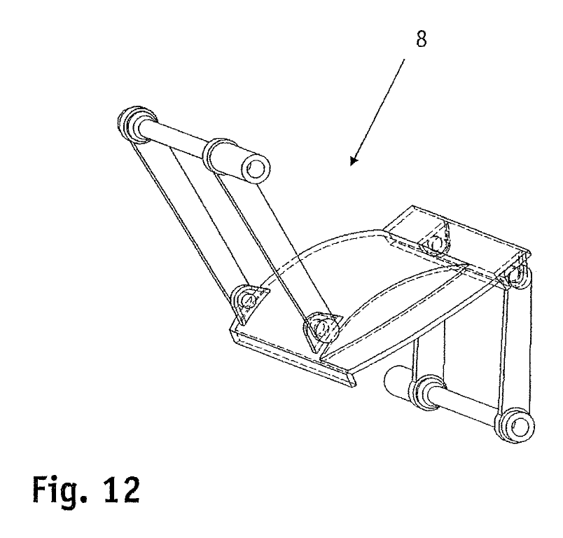

FIG. 12 shows a diagrammatic perspective illustration of a mixing flap in a second embodiment, having articulation elements.

FIG. 1 shows an air conditioning unit 1 according to the invention in a cross-sectional illustration. A fan 3 (not shown), preferably a radial ventilator, which sucks in air perpendicularly with respect to the sectional plane is arranged within a region of the housing. The air which is conveyed by the radial ventilator first of all flows through an air filter 4 and then the evaporator 5, in which the air is cooled.

Downstream of the evaporator 4, a cold air inlet region, via which a cold air flow 15 can enter the mixing chamber 17, and a flow duct 18 which is called a heating element inlet duct connect into the mixing chamber opening 14. The air which flows into the flow duct 18 passes a heat exchanger 6 downstream of the evaporator 5, which heat exchanger 6 is configured as a heating element, and a supplementary heating element 7, for example a PTC heating element. Heated air as a warm air flow 16 passes via the flow duct 13 which is called a warm air duct and is situated downstream of the heating body 6 into the mixing chamber 17 after passing the mixing chamber opening 19. The mixing chamber openings (14, 19) for cold and warm air are arranged immediately adjacently to one another.

The mixing flap 8 can be moved between two positions and determines with its position the ratio between the cold air flow 15 which enters the mixing chamber through the mixing chamber opening 14 and the warm air flow 16 which enters the mixing chamber via the mixing chamber opening 19. The temperature which is set of the resultant mixing air is controlled or regulated in this way in the mixing chamber 17.

A plurality of air outlet ducts 11 are situated in a manner which branches off from the mixing chamber 17, each of these ducts being assigned a control flap 12, by means of which the magnitude of the air flow in the corresponding air outlet ducts 11 can be controlled or regulated.

FIG. 1 shows the mixing flap 8 in a first end position, said mixing flap 8 closing the passage of the warm air flow 16 through the mixing chamber opening 19. The total air flow which exits the evaporator 4 is guided as cold air flow 15 via the mixing chamber opening 14 into the mixing chamber 17.

FIG. 2 shows an enlarged cross-sectional view of the mixing flap 8 and a part region of the air conditioning unit 1 with the same flap position as in FIG. 1. The mixing flap 8 is positioned and moved via two articulation means 9 which are configured in the form of lever arms. The lever arms have rotational axes 20 which are spaced apart from one another and are stationary with regard to the housing 2. At those ends of the lever arms which lie opposite the rotational axes 20, they are connected in an articulated manner to the wall region 10, for example via brackets 21 which are injection molded onto the wall region 10. In the exemplary embodiment which is shown, the articulation means 9 which are configured as lever arms are configured with identical lengths.

In cross section, the wall region 10 has a concavely curved profile with regard to the rotational axes 20, which extends in the longitudinal direction (perpendicularly with respect to the plane of the drawing) of the mixing flap. Terminating or end walls 22 are situated at the two end faces of the mixing flap 17, the outer sides of which are adjoined by a web 24, in order to ensure lateral sealing of the mixing flap 8 with respect to the housing 2 in the end positions. Stop faces 23 are situated on both sides in an adjoining manner to the wall region 10, which stop faces 23 are configured to be continuous over the entire length of the mixing flap 8 and bear in a sealing manner against correspondingly configured stop faces 25 on the housing 2 of the air conditioning unit 1 in the end positions. The stop faces 23 are preferably provided with a corresponding fluidtight coating, for example a foam material or an elastic, injection molded sealing lip.

FIG. 3 shows the mixing flap 8 in a second end position, said mixing flap 8 closing the passage of the cold air flow 15 through the mixing chamber opening 14. The entire air flow which exits the evaporator 5 is guided as warm air flow 13 into the mixing chamber 17 via the heating element inlet duct 18, the heating element 6 and the supplementary heater 7. The stop faces 23 on the mixing flap 8 and the stop faces 25 on the housing 2 also ensure sealing of the cold air inlet region in this second end position which is shown.

FIG. 4 shows the mixing flap 8 in an intermediate position. Neither the mixing chamber opening 14 for the cold air flow 15 nor the mixing chamber opening 19 for the warm air flow 16 are closed or opened completely. The flow path of the air flow which comes from the evaporator 5 can be seen using the illustrated arrows. Here, the cold air flow 15 is divided into a first part flow which passes directly into the mixing chamber 17 and a second part flow which is deflected via the wall region 10 of the mixing flap 8 into the warm air duct 13, where it is mixed with the part air flow 13 which has passed through the heating element 6. Gentle deflection of the cold part flow is possible as a result of the shape of the wall region 10, which shape is configured in a manner which is favorable to flow, as can be seen from FIG. 4.

The sequence of the movement of a mixing flap 8 according to the invention is to be illustrated by means of FIGS. 5 and 6. Starting from a first end position, in which both the stop faces 23 of the mixing flap 8 bear sealingly against the housing stops 25, the mixing chamber opening 14 is sealed by means of the sealing web 24 which is configured in the shape of annular segments and a sealing web 26 on the end sides of the mixing flap 8, which sealing web 26 is configured in a corresponding manner on the housing wall. The web 24 is preferably provided with a corresponding fluidtight coating, for example a foam material or an elastic, injection molded sealing lip. If the mixing flap moves from this end position into the center position which is shown in FIG. 6, it can be seen that, in particular, the wall region 10 performs a movement which deviates from a pure rotation and is composed of a translation and a rotation. As a result, the sealing web 24 is raised off from or deflected downward away from the web 26 which is situated on the housing in a stationary manner. As these webs (24, 26) act as sealing edges or sealing faces and move further away from one another during the movement, the friction is also reduced between them or a sealing lip which is attached to or injection molded on the mixing flap 8 and the housing, which has the consequence that a lower torque is required for the movement of the mixing flap 8 than in a constant spacing between the webs (24, 26) in the case of a pure rotational movement. After the possibility has been provided in any case by the shape of the wall region 10 and the movement sequence in the intermediate positions of the mixing flap 8, it is not necessary to seal the mixing flap 8 on the end sides in the intermediate positions for direct passage of cold air into the warm air duct 13. Rather, it is decisive that the torque which is necessary for the movement is reduced and nevertheless the sealing function is maintained in the two end positions.

FIGS. 7 and 8 show further perspective views of a mixing flap 8 according to the invention. The articulation of a mixing flap 8 is illustrated again, in the exemplary embodiment shown via four articulation means 9 which are configured as lever arms and in each case in pairs have a common rotational axis 20. The wall region 10 of the mixing flap 8 is divided laterally into two sections of different curvature, in order, for example, to achieve satisfactory mixing of cold and warm part air flows in a first region of the mixing chamber 17 and in order to achieve more pronounced temperature stratification in the mixing chamber or in the air ducts 11 which branch off from the latter in a second region. In principle, an offset end wall 22 serves as connection between the regions of different curvature of the wall region 10.

The sealing webs 26 of the housing 2 and the housing stop faces 25 can be seen perspectively in FIG. 8. The sealing function of the mixing flap 8 results, as described above, from the interaction with the sealing webs 24 and stop faces 23 of the mixing flap 8.

FIGS. 9 to 12 show one exemplary embodiment of a further variant according to the invention. In contrast to the embodiments which are shown in FIGS. 2 to 8, the rotational axes 20 of the articulation means 9 are spaced substantially further apart from one another. In the example which is shown, a first rotational axis 20 lies in the region of the mixing chamber 17 and a second rotational axis 20 lies in the region of the cold air flow 15 downstream of the mixing chamber opening 14. The lever arms of the articulation means 9 are configured with different lengths.

In an analogous manner to FIG. 2, FIG. 9 shows the mixing flap 8 in a first end position, said mixing flap 8 closing the passage of the warm air flow 16 through the mixing chamber opening 19. The entire air flow which exits the evaporator 4 is guided as cold air flow 15 via the mixing chamber opening 14 into the mixing chamber 17.

In a corresponding manner to FIG. 3, FIG. 10 shows the mixing flap 8 in a second end position, said mixing flap 8 closing the passage of the cold air flow 15 through the mixing chamber opening 14. The entire air flow which exits the evaporator 5 is guided as warm air flow 16 via the heating element inlet duct 18, the heating element 6, and the supplementary heater 7 into the mixing chamber 17.

In a manner according to the illustration in FIG. 4, FIG. 11 shows the mixing flap 8 in an intermediate position. Neither the mixing chamber opening 14 for the cold air flow 15 nor the mixing chamber opening 19 for the warm air flow 16 are closed or opened completely. The flow path of the air flow which comes out of the evaporator 5 can be seen using the illustrated arrows. Here, the cold air flow 15 is divided into a first part flow which passes directly into the mixing chamber 17 and a second part flow which is deflected via the wall region 10 of the mixing flap 8 into the warm air duct 13, where it is mixed with the part air flow which has passed through the heating element 6. Gentle deflection of the cold part flow is possible as a result of the shape of the wall region 10, which shape is configured in a manner which is favorable to flow, as can be seen from FIG. 4.

FIG. 12 shows a perspective illustration of a mixing flap 8 according to the sectional images of FIGS. 9 to 1. The articulation of a mixing flap 8 is once again shown here, in the exemplary embodiment shown via four articulation means 9 which are configured as lever arms and which in each case in pairs have a common rotational axis 20. The wall region 10 of the mixing flap 8 is divided laterally into two sections of different curvature, in order, for example, to achieve satisfactory mixing of cold and warm part air flows in a first region of the mixing chamber 17 and in order to achieve more pronounced temperature stratification in the mixing chamber or in the air ducts 11 which branch off from the latter in a second region. In principle, an offset rear wall 22 serves as connection between the regions of different curvature of the wall region 10.

For the embodiment of the mixing flap which is shown in FIGS. 9 to 12, the movement between the two end positions likewise takes place in the form of a mixed form which is composed of a rotation and a translation. The deviation from a rotational movement is substantially greater than, for example, in the exemplary embodiment which is shown in FIG. 7. As a result of the variation of the arrangement of the rotational axes 20 which are stationary in the housing 2, the articulation means 9 and the length of the lever arms, the mixing flap 8 can be adapted in an optimum manner to the respective requirements of the desired mixing ratio of warm and cold air or the cross-sectional area for the direct passage of the cold air flow into the warm air duct 8 during the opening or closing movement. Adaptation can likewise be carried out to installation space stipulations or restrictions.

### LIST OF DESIGNATIONS

1 Heating and/or air conditioning unit
2 Housing
3 Fan
4 Filter
5 Evaporator
6 Heating element
7 Supplementary heater
8 Mixing flap
9 Articulation means (lever)
10 Wall region
11 Air ducts
12 Control flaps
13 Warm air duct
14 Mixing chamber opening—cold air
15 Cold air flow
16 Warm air flow
17 Mixing chamber
18 Heating element inlet duct
19 Mixing chamber opening—warm air
20 Rotational axis
21 Bracket
22 End wall
23 Stop face—mixing flap
24 Sealing web—flap
25 Stop face—housing
26 Sealing web—housing

1. A heating and/or air conditioning unit for vehicles, having a housing, a fan, at least one heat exchanger, in particular a heating element, optionally an evaporator which is arranged in front of the heating element in the flow direction, an inlet air flow which can be divided into at least one first part air flow and at least one second part air flow before entry into a mixing chamber, the at least first part air flow opening into a mixing chamber directly or via an air duct and the at least second part air flow being guided via the heating element and opening into the mixing chamber via a warm air duct, having a plurality of air ducts and/or air flow control means which emanate from the mixing chamber, and having at least one mixing flap having a wall region which can be moved between a first and a second end position, the wall region of the mixing flap closing the opening for the entry of the at least first part air flow into the mixing chamber completely in the first end position, and the wall region of the mixing flap closing the opening for the entry of the at least second part air flow into the mixing chamber completely in a second end position and making direct passage possible of the at least first part air flow into the warm air duct in the positions which are situated in between, wherein the mixing flap can be moved via at least two articulation means which are arranged in such a way that, during the movement of the mixing flap, at least one part region, in particular the wall region, of the mixing flap performs a movement which is composed of a rotation and a translation.

2. The heating and/or air conditioning unit as claimed in claim 1, wherein the at least two articulation means of the mixing flap are mounted rotatably in each case on an axis which is stationary with respect to the housing, the axes being spaced apart from one another.

3. The heating and/or air conditioning unit as claimed in claim 1, wherein the at least two articulation means of the mixing flap are configured in the form of lever arms.

4. The heating and/or air conditioning unit as claimed in claim 1, wherein the mixing flap has means for the articulated connection of the at least two articulation means to the mixing flap.

5. The heating and/or air conditioning unit as claimed in claim 1, wherein at least two articulation means of the mixing flap are configured with identical lengths.

6. The heating and/or air conditioning unit as claimed in claim 1, wherein at least two articulation means of the mixing flap are configured with different lengths.

7. The heating and/or air conditioning unit as claimed in claim 1, wherein the rotational axes of the articulation elements of the mixing flap lie in the region of the mixing chamber.

8. The heating and/or air conditioning unit as claimed in claim 1, wherein at least the rotational axis of a first articulation element of the mixing flap lies in the region of the mixing chamber and the rotational axis of a second articulation element of the mixing flap lies in the region of the first or second part air flow.

9. The heating and/or air conditioning unit as claimed in claim 1, wherein the wall region of the mixing flap is of at least partial circular or circular segment shape in cross section.

10. The heating and/or air conditioning unit as claimed in claim 1, wherein the wall region of the mixing flap is configured at least partially in an elliptic, parabolic, hyperbolic or another continuously curved shape.

11. The heating and/or air conditioning unit as claimed in claim 1, wherein the wall region of the mixing flap is configured at least partially as a flat surface piece.

12. The heating and/or air conditioning unit as claimed in claim 1, wherein the wall region of the mixing flap has laterally divided regions, in particular of different curvature.

13. The heating and/or air conditioning unit as claimed in claim 1, wherein the mixing flap has a wall region which is continuously constant over its entire surface area.

14. The heating and/or air conditioning unit as claimed in claim 1, wherein the mixing flap has a single-piece wall region.

15. The heating and/or air conditioning unit as claimed in claim 1, wherein the housing has at least one end stop for at least one end position of the mixing flap.

16. The heating and/or air conditioning unit as claimed in claim 1, wherein the wall region of the mixing flap has at least one stop or one stop face for at least one end position of the mixing flap.

17. The heating and/or air conditioning unit as claimed in claim 1, wherein the wall region of the mixing flap has a sealing means on its circumference.

18. The heating and/or air conditioning unit as claimed in claim 1, wherein the sealing means is configured as a sealing lip which is injection molded or foamed onto said sealing means.

19. The heating and/or air conditioning unit as claimed in claim 1, wherein the housing is configured, at least in one of the end positions of the mixing flap, with sealing edges in the region of the end sides of the wall region of the mixing flap.

20. The heating and/or air conditioning unit as claimed in claim 1, wherein the sealing edges are configured in the form of webs or protruding regions on the housing.
